(19) United States
(12) Patent Application Publication
(10) Pub. No.: US 2018/0346068 A1
(43) Pub. Date: Dec. 6, 2018

(54) BICYCLE REAR DERAILLEUR

(71) Applicant: TEKTRO TECHNOLOGY CORPORATION, Changhua County (TW)

(72) Inventor: JOHN L. CALENDRILLE, JR., Port Jefferson, NY (US)

(21) Appl. No.: 15/640,144

(22) Filed: Jun. 30, 2017

(30) Foreign Application Priority Data
May 31, 2017 (TW) 106117920

(51) Int. Cl. B62M 9/125; F16B 2/18

(52) U.S. Cl. CPC B62M 9/125; F16B 2/185

(57) ABSTRACT

A bicycle rear derailleur, adapted to be mounted on a bicycle frame, comprises a mounting frame assembly, a linkage assembly and a movable assembly. The mounting frame assembly comprises a pivot, a main frame, a resistance applying member and a resistance controller. The pivot is adapted to be fixed on the bicycle frame. The main frame is rotatably disposed on the pivot. The resistance-applying member is disposed on the main frame, and the resistance-applying member is configured to apply a force on the pivot so as to adjust a rotational resistance of the main frame. The resistance controller is disposed on the main frame, and the resistance controller is configured to control the resistance-applying member to adjust the force applied on the pivot. The linkage assembly is pivoted to the mounting frame assembly. The movable assembly is pivoted to the linkage assembly.

### CROSS-REFERENCE TO RELATED APPLICATIONS

This non-provisional application claims priority under 35 U.S.C. § 119(a) on Patent Application No(s). 106117920 filed in Taiwan, R.O.C. on May 31, 2017, the entire contents of which are hereby incorporated by reference.

### TECHNICAL FIELD

The disclosure relates to a bicycle rear derailleur, more particularly to a bicycle rear derailleur capable of absorbing impact and being positioned in place.

### BACKGROUND

In recent years, road bikes, mountain bikes and other types of bicycles are all popular in the market, and it motivates bicycle manufacturers to pay more attention on improving their products. Generally, a bicycle has front sprockets on an output shaft and rear sprockets on a rear wheel hub, and there is a chain wrapped around the front sprockets and the rear sprockets. When a rider pedals the bicycle to rotate the front sprockets, the front sprockets can drive the rear sprockets to rotate through the chain so as to move the bicycle. Moreover, the bicycle is usually provided with derailleurs to switch the position of the chain. In detail, there are a front derailleur and a rear derailleur; the front derailleur is configured to move the chain among the front sprockets, and a rear derailleur is configured to move the chain among the rear sprockets. By using the front derailleur and the rear derailleur to switch the position of the chain, the gear ratio between the front sprockets and the rear sprockets can be changed.

### SUMMARY

One embodiment of the disclosure provides a bicycle rear derailleur, which is adapted to be mounted on a bicycle frame. The bicycle rear derailleur comprises a mounting frame assembly, a linkage assembly and a movable assembly. The mounting frame assembly comprises a pivot, a main frame, a resistance applying member and a resistance controller. The pivot is adapted to be fixed on the bicycle frame. The main frame is rotatably disposed on the pivot. The resistance-applying member is disposed on the main frame, and the resistance-applying member is configured to apply a force on the pivot so as to adjust a rotational resistance of the main frame. The resistance controller is disposed on the main frame, and the resistance controller is configured to control the resistance-applying member to adjust the force applied on the pivot. The linkage assembly is pivoted to the mounting frame assembly. The movable assembly is pivoted to the linkage assembly.

One embodiment of the disclosure provides a bicycle rear derailleur, which is adapted to be mounted on a bicycle frame. The bicycle rear derailleur comprises a mounting frame assembly, a linkage assembly and a movable assembly. The mounting frame assembly comprises a pivot, a main frame, a gasket and a shaft. The pivot is adapted to be fixed on the bicycle frame. The main frame is rotatably disposed on the pivot. The gasket is located between the main frame and the bicycle frame. The gasket is adapted to be fixed on the bicycle frame. The pivot is disposed through the main frame and the gasket. The main frame is rotatable with respect to the gasket. The shaft is disposed through the main frame. The linkage assembly is pivoted to the mounting frame assembly. The movable assembly is pivoted to the linkage assembly. The main frame is rotatable to a first position and a second position. The shaft has a pressing end. When the main frame is in the first position, the pressing end is next to a surface of the gasket facing the main frame. When the main frame is in the second position, the shaft is movable along an axis thereof, thereby allowing the pressing end of the shaft to press against the gasket.

### BRIEF DESCRIPTION OF THE DRAWINGS

The present disclosure will become more fully understood from the detailed description given hereinbelow and the accompanying drawings which are given by way of illustration only and thus are not intending to limit the present disclosure and wherein:

FIG. 1 is a perspective view of a bicycle rear derailleur in accordance with a first embodiment of the disclosure;

FIG. 2 is a perspective view of some components of a mounting frame assembly and a gasket in FIG. 1;

FIG. 3 is an exploded view of the mounting frame assembly and the gasket in FIG. 1;

FIG. 4 is a side view of a cam in FIG. 2 in a strengthening position;

FIG. 5 is a side view of the cam in FIG. 2 in a releasing position;

FIG. 6 is a side view of the relative position of a handle and a main frame in FIG. 1 while the cam is in the strengthening position;

FIG. 7 is a side view of the relative position of the handle and the main frame in FIG. 1 while the cam is in the releasing position;

FIG. 8 is a perspective view of the mounting frame assembly in FIG. 1 in a first position;

FIG. 9 is a perspective view of the mounting frame assembly in FIG. 1 in a second position;

FIG. 10 is a perspective view of a shaft in FIG. 9 in a fourth position; and

FIG. 11 is a side view of a control assembly, a cam and a clamping sleeve in accordance with a second embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

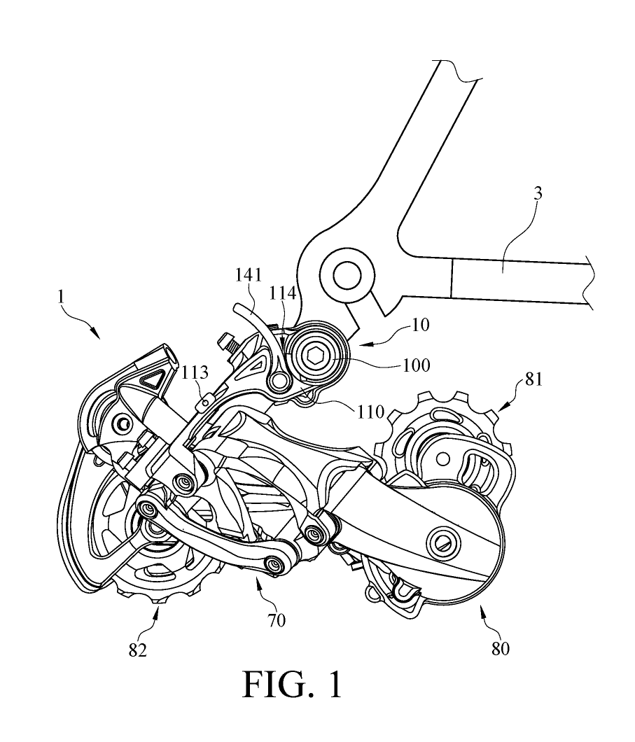

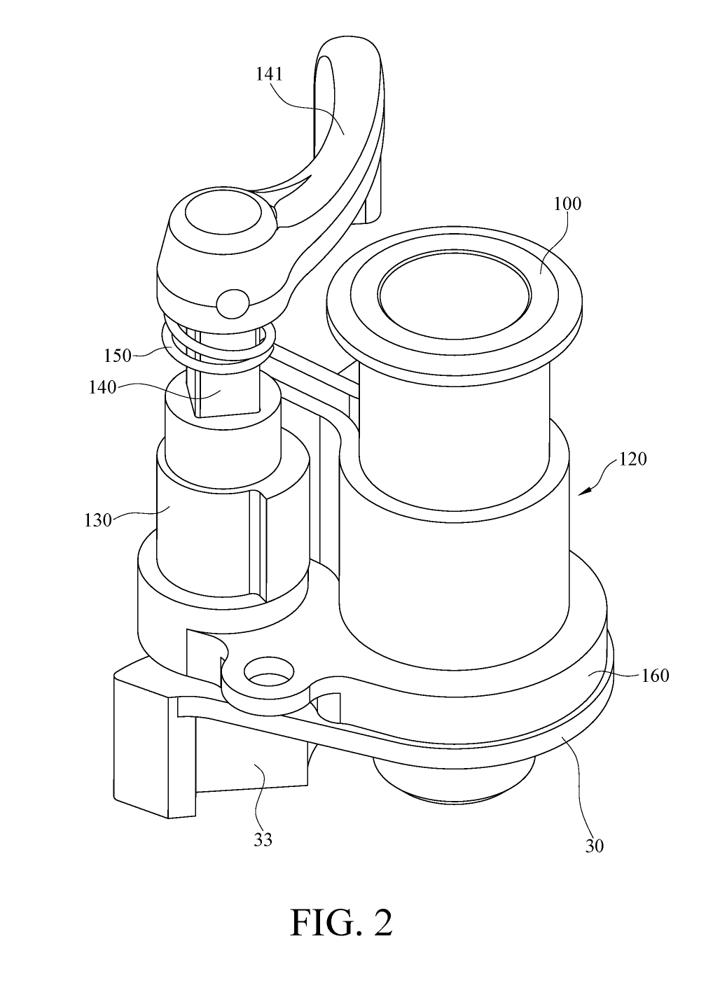

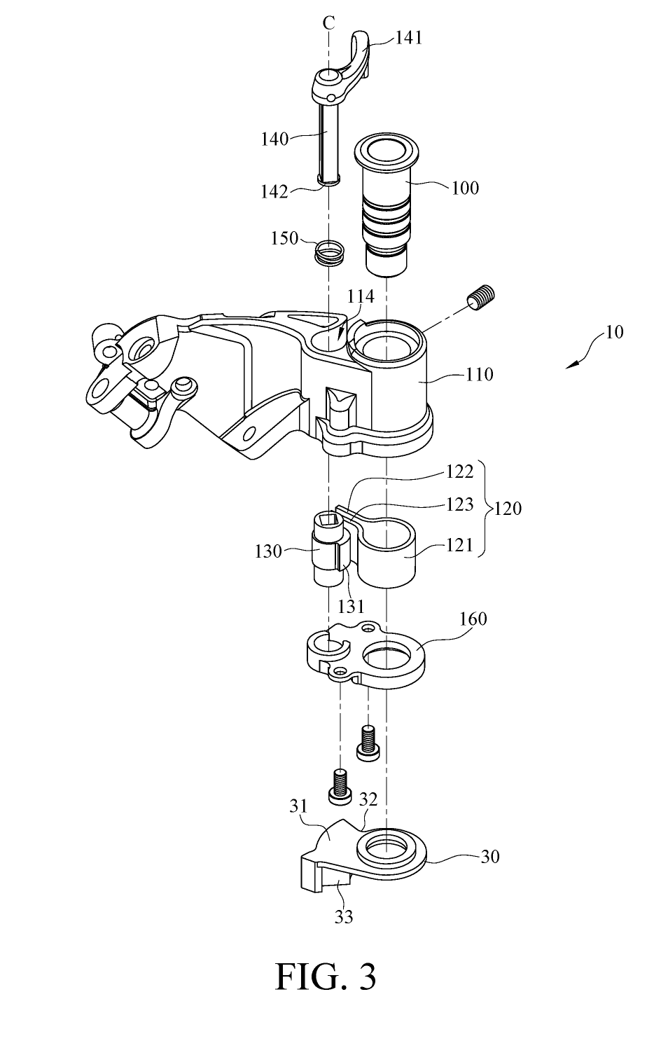

Please refer to FIG. 1 to FIG. 3. FIG. 1 is a perspective view of a bicycle rear derailleur in accordance with a first embodiment of the disclosure. FIG. 2 is a perspective view of some components of a mounting frame assembly and a gasket in FIG. 1. FIG. 3 is an exploded view of the mounting frame assembly and the gasket in FIG. 1.

In this embodiment, a bicycle rear derailleur 1 is provided. The bicycle rear derailleur 1 includes a mounting frame assembly 10, a linkage assembly 70 and a movable assembly 80.

The mounting frame assembly 10 is adapted to be mounted onto a bicycle frame 3. The linkage assembly 70 includes, for example, two connecting rods. Two ends of each connecting rod are respectively pivoted to the mounting frame assembly 10 and the movable assembly 80, and therefore the linkage assembly 70, the mounting frame assembly 10 and the movable assembly 80 together form a four-bar linkage structure. The movable assembly 80 is adapted to connect to a guide pulley 81 and a tension pulley 82. The guide pulley 81 and the tension pulley 82 are configured for a chain (not shown) to be disposed thereon; the guide pulley 81 is able to move the chain to different sprockets, and the tension pulley 82 is able to keep the chain tight. In this embodiment, the movable assembly 80 is movable relative to the mounting frame assembly 10 through the linkage assembly 70. In addition, in this embodiment, the bicycle rear derailleur 1 further includes a gasket 30, adapted to be disposed on the bicycle frame 3, which will be described in more detail later on.

As shown in FIG. 2 and FIG. 3, the mounting frame assembly 10 includes a pivot 100, a main frame 110, a resistance-applying member 120, a resistance controller 130, a shaft 140, a handle 141, a spring 150 and a side cover 160. The pivot 100 is adapted to be fixed on the bicycle frame 3. The main frame 110 is rotatably disposed on the pivot 100.

The resistance-applying member 120 is disposed on the main frame 110, and the resistance applying member 120 is configured to apply a force on the pivot 100 so as to adjust a rotational resistance of the main frame 110. In this embodiment, the resistance-applying member 120 is a clamping sleeve, but the present disclosure is not limited thereto. The clamping sleeve 120 includes a clamping part 121, a fixed part 122 and a movable part 123. The fixed part 122 and the movable part 123 are respectively connected to two ends of the clamping part 121. The fixed part 122 is fixed to the main frame 110. The clamping part 121 surrounds the pivot 100, such that the movable part 123 and fixed part 122 are adjacent to each other with a distance therebetween.

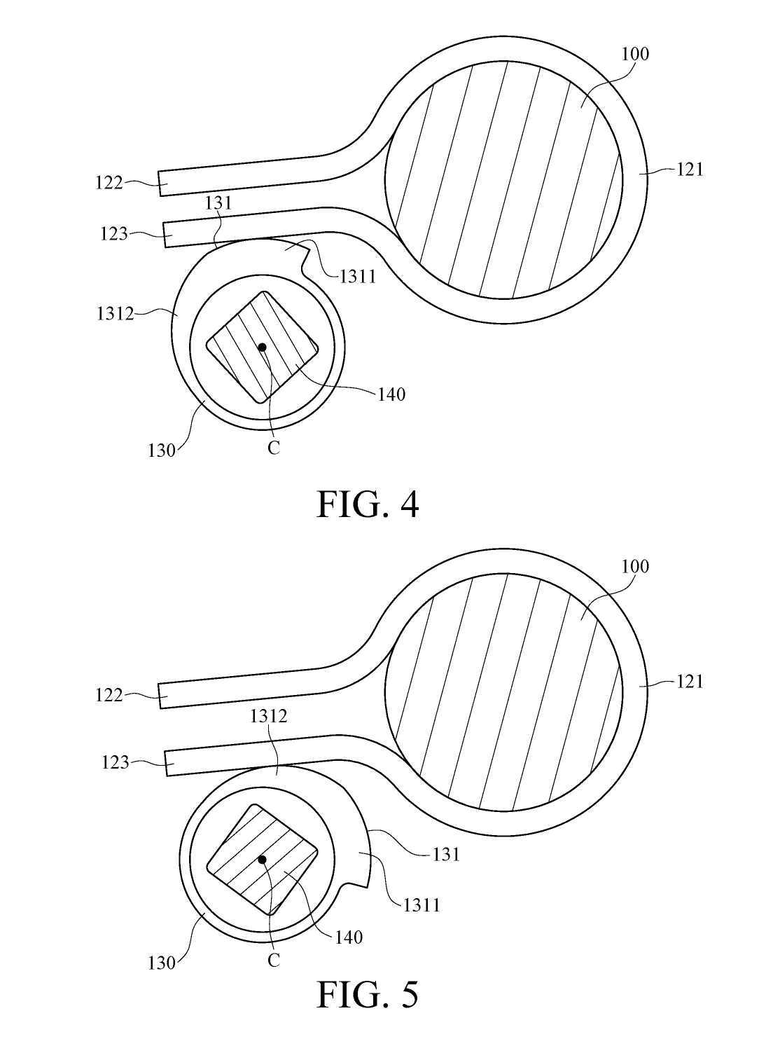

Please refer to FIG. 4 and FIG. 5. FIG. 4 is a side view of a cam in FIG. 2 in a strengthening position. FIG. 5 is a side view of the cam in FIG. 2 in a releasing position. The resistance controller 130 is disposed on the main frame 110, and the resistance controller 130 is configured to control the resistance-applying member 120 to adjust its force applied on the pivot 100. In this embodiment, the resistance controller 130 is a cam. The cam 130 is pivoted to the main frame 110, and the cam 130 is adjacent to the movable part 123 of the clamping sleeve 120. The cam 130 is pivotable between a strengthening position and a releasing position about an axis C. When the cam 130 is rotated relative to the main frame 110, the movable part 123 is moved toward or away from the fixed part 122 by being pushed by the cam 130 so as to adjust the clamping strength of the clamping part 121. In detail, the cam 130 has a curved pressing surface 131, and the curved pressing surface 131 has a first side 1311 and a second side 1312 opposite to each other. A distance between the curved pressing surface 131 and the axis C decreases from the first side 1311 to the second side 1312. When the cam 130 is rotated to the strengthening position, the movable part 123 is pushed by the curved pressing surface 131 with the first side 1311 thereof, such that the movable part 123 is relatively close to the fixed part 122. As a result, an inner diameter of the clamping part 121 is decreased, and therefore the clamping strength of the clamping part 121 is increased. When the cam 130 is rotated to the releasing position, the movable part 123 is pushed by the curved pressing surface 131 with the second side 1312 thereof, such that the movable part 123 is relatively away from the fixed part 122. It is understood that the inner diameter of the clamping part 121 is increased, and the clamping strength of the clamping part 121 is decreased. In addition, it is noted that the resistance controller 130 is not limited to be a cam. In some embodiments, the resistance controller may be a pushing rod or a spring.

The shaft 140 is movably disposed through the cam 130. The handle 141 is connected to one end of the shaft 140. The handle 141 is configured to rotate the shaft 140 and the cam 130 about the axis C, and also configured to move the shaft 140 along the axis C.

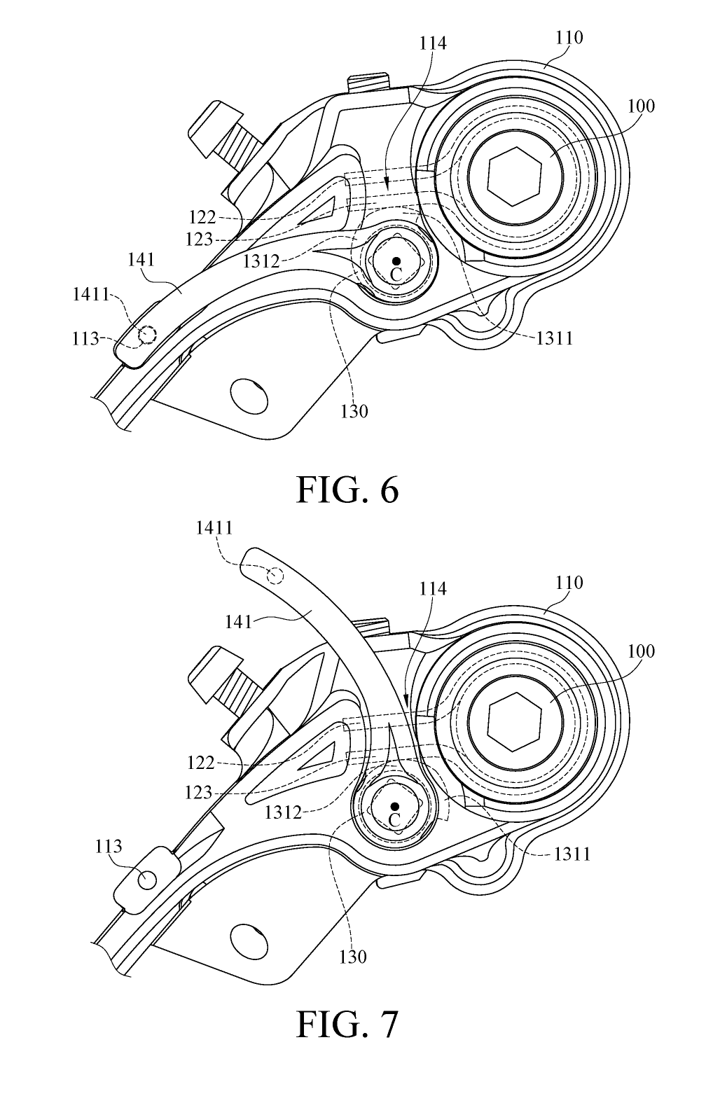

Please refer to FIG. 6 and FIG. 7. FIG. 6 is a side view of the relative position of a handle and a main frame in FIG. 1 while the cam is in the strengthening position. FIG. 7 is a side view of the relative position of the handle and the main frame in FIG. 1 while the cam is in the releasing position. The handle 141 has a first positioning portion 1411 at one end away from the shaft 140. The main frame 110 has a second positioning portion 113 and a recess 114. The first positioning portion 1411 is a protrusion, and the second positioning portion 113 is a cavity. When the cam 130 is rotated to the strengthening position by the shaft 140, the first positioning portion 1411 of the handle 141 is engaged with the second positioning portion 113 of the main frame 110, such that the handle 141 is fixed on the main frame 110, and therefore the cam 130 is fixed in the strengthening position. When the cam 130 is rotated to the releasing position by the shaft 140, the handle 141 is next to the mouth of the recess 114, such that the handle 141 is able to be moved into the recess 114 to move the shaft 140 toward the bicycle frame 3 along the axis C, the purpose of which will be described later on.

In this embodiment, the first positioning portion 1411 is a protrusion, and the second positioning portion 113 is a cavity, but the present disclosure is not limited thereto. In other embodiments, the first positioning portion may be a cavity, and the second positioning portion may be a protrusion able to be engaged into the cavity.

The spring 150 is sleeved on the shaft 140. Two ends of the spring 150 respectively press against the handle 141 and the main frame 110. The spring 150 is configured to provide a force on the handle 141 to move it away from the bicycle frame 3 along the axis C.

The side cover 160 is disposed on the main frame 110 so as to fix the clamping sleeve 120 and the cam 130 in the main frame 110. In addition, the shaft 140 is able to penetrate the side cover 160 along the axis C.

The gasket 30 is located between the main frame 110 of the mounting frame assembly 10 and the bicycle frame 3, and the pivot 100 is disposed through the gasket 30. The gasket 30 has a surface 31 and a protruding engage portion 33. The surface 31 faces the main frame 110. The protruding engage portion 33 is adapted to be fixed to the bicycle frame 3 so the gasket 30 is immovably fixed to the bicycle frame 3. In addition, the surface 31 has a press edge 32.

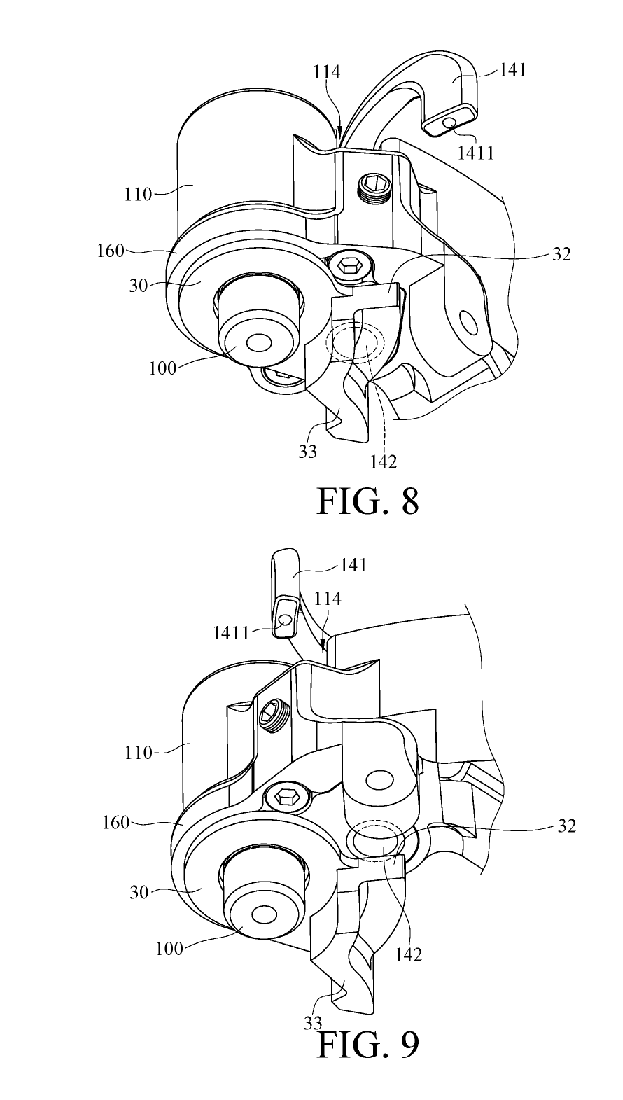

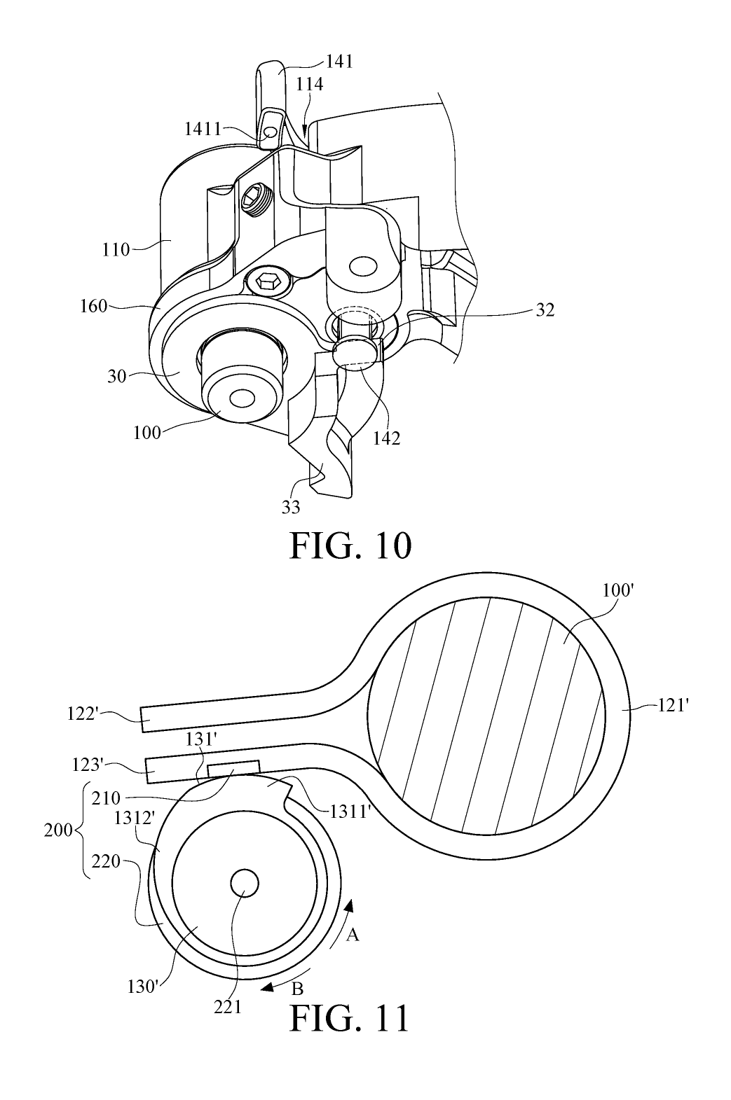

The operation of the bicycle rear derailleur 1 is described hereafter. Please refer to FIG. 8 to FIG. 10. FIG. 8 is a perspective view of the mounting frame assembly in FIG. 1 in a first position. FIG. 9 is a perspective view of the mounting frame assembly in FIG. 1 in a second position. FIG. 10 is a perspective view of a shaft in FIG. 9 in a fourth position.

Firstly, when the cam 130 is rotated to the releasing position by the handle 141 through the shaft 140 (as shown in FIG. 5), the clamping strength of the clamping sleeve 120 is small; that is, the clamping sleeve 120 applies relative small force on the pivot 100, and therefore the main frame 110 is able to be rotated with respect to the pivot 100 easily to a first position and a second position. The first position is the position of the main frame 110 when the bicycle is in use. The second position is the position of the main frame 110 that allows the rear wheel to be removed. More specifically, when the main frame 110 is rotated from the first position to the second position, for example, in a clockwise direction as seen from the viewpoint of FIG. 1, the tension pulley 82 is driven to move toward the rear side of the bicycle to keep the chain (not shown) tight and offer additional clearance, and it is beneficial to remove the rear wheel. In addition, when the main frame 110 is in the first position, the cam 130 is able to change its position to adjust the clamping strength of the clamping part 121 according to actual requirements.

As shown in FIG. 8, the main frame 110 is in the first position, and a pressing end 142 of the shaft 140, which is away from the handle 141, is pressed against the surface 31 of the gasket 30, such that the shaft 140 is blocked by the gasket 30. As a result, the shaft 140 is prevented from moving along the axis C, but is rotatable with respect to the gasket 30. Furthermore, in this embodiment, it is also possible to prevent the shaft 140 from moving along the axis C by pressing the handle 141 against the main frame 110.

It is noted that, in this embodiment, the handle 141 is pressed against the main frame 110 when the cam 130 is not in the releasing position (e.g. a position between the releasing position and the strengthening position, or the strengthening position), but the present disclosure is not limited thereto. In some embodiments, the handle 141 may be spaced apart from the main frame 110.

As shown in FIG. 9 and FIG. 10, the main frame 110 is in the second position, and the shaft 140 is not blocked by the gasket 30, such that the shaft 140 is movable between a third position and a fourth position along the axis C. When the shaft 140 is moved from the third position (as shown in FIG. 9) to the fourth position (as shown in FIG. 10), the pressing end 142 of the shaft 140 protrudes from the side cover 160 and is pressed against the press edge 32 of the surface 31, and thereby maintaining the main frame 110 in the second position, making it easier to remove the rear wheel.

After the rear wheel is replaced, the main frame 110 is able to be moved back to the first position once the shaft 140 is pulled back to the third position. In addition, in this embodiment, when the handle 141 is placed into the recess 114 of the main frame 110, the spring 150 between the handle 141 and the main frame 110 is compressed to store elastic energy. As a result, when the shaft 140 is to be pulled back to the third position, the spring 150 can provide the stored elastic energy serving as a return force for the handle 141 so that the handle 141 is able to be easily pulled out of the recess 114.

In this embodiment, the shaft 140 and the cam 130 are two independent components, and are connected and moved together through the shaft 140, but the present disclosure is not limited thereto. In other embodiments, the shaft and the cam may be formed as one piece.

In addition, the spring 150 is optional, and the present disclosure is not limited thereto. In other embodiments, the mounting frame assembly may not include the spring 150.

Furthermore, in other embodiments, when the main frame 110 is in the first position, the pressing end 142 of the shaft 140 may not be in contact with the surface 31 of the gasket 30, the present disclosure is not limited thereto.

In this embodiment, the handle 141 is provided for adjusting the position of the cam 130, but the present disclosure is not limited thereto. In other embodiments, the cam 130 may be rotated by a motor. For example, please refer to FIG. 11, which is a side view of a control assembly, a cam and a clamping sleeve in accordance with a second embodiment of the disclosure.

In this embodiment, a bicycle rear derailleur includes a control assembly 200. The control assembly 200 includes a sensor 210 and a driver 220. The sensor 210 is, for example, a pressure sensor, and the driver 220 is, for example, a motor. As shown in FIG. 11, the sensor 210 is disposed between the curved pressing surface 131′ of the cam 130′ and the movable part 123′. In this embodiment, the sensor 210 is disposed onto a surface of the movable part 123′ facing the curved pressing surface 131′ so as to detect the magnitude of force, on the movable part 123′, applied by the cam 130′. The driver 220 is disposed on the cam 130′, and the driver 220 has a driving shaft 221 disposed through the cam 130′. The driving shaft 221 is able to rotate the cam 130′ in a direction of arrow A or a direction of arrow B as shown in FIG. 11 so as to adjust the force, on the movable part 123′, applied by the cam 130′, thereby adjusting the clamping strength of the clamping part 121′ to adjust the movability of the main frame 110 with respect to the bicycle frame 3.

It is noted that, the bicycle rear derailleur 1 in the first embodiment is also able to move the shaft 140 via the automatic manner as being used in the second embodiment.

According to the bicycle rear derailleur as described above, the cam is rotatably pressed against the clamping sleeve, such that it is possible to adjust the clamping strength of the clamping sleeve according to actual requirements. Accordingly, for example, when riding on a bumpy road, the bicycle rear derailleur may encounter great impacts that exceed the tension of the spring on the cage and the restriction of the clutch, but the movements of the bicycle rear derailleur and the chain are properly minimized while the pivot is clamped by the clamping sleeve; as a result, the bicycle rear derailleur is prevented from being damaged, and the chain is prevented from falling off.

In addition, the bicycle rear derailleur is able to be moved toward the rear side of the bicycle to leave a larger space between the bicycle rear derailleur and the rear wheel, and the bicycle rear derailleur is able to be fixed in place when the shaft is pressed against the gasket. Therefore, it is favorable for removing the rear wheel.

Furthermore, the cam is able to be moved by the control assembly. Therefore, the adjustment of the cam is instant, providing a better experience for the users.

The embodiments were chosen and described in order to best explain the principles of the disclosure and its practical applications, to thereby enable others skilled in the art to best utilize the disclosure and various embodiments with various modifications as are suited to the particular use contemplated. It is intended that the scope of the disclosure be defined by the following claims and their equivalents.

What is claimed is:

1. A bicycle rear derailleur, adapted to be mounted on a bicycle frame, comprising:
a mounting frame assembly, comprising:
a pivot, adapted to be fixed on the bicycle frame;
a main frame, rotatably disposed on the pivot;
a resistance applying member, disposed on the main frame, configured to apply a force on the pivot so as to adjust a rotational resistance of the main frame; and
a resistance controller, disposed on the main frame, configured to control the resistance applying member to adjust the force applied on the pivot;
a linkage assembly, pivoted to the mounting frame assembly; and
a movable assembly, pivoted to the linkage assembly.

2. The bicycle rear derailleur according to claim 1, wherein the resistance applying member is a clamping sleeve, and the resistance controller is a cam, the clamping sleeve comprises a clamping part, a fixed part and a movable part, the fixed part and the movable part are respectively connected to two ends of the clamping part, the fixed part is fixed to the main frame, the clamping part surrounds the pivot, the cam is pivoted to the main frame, and the cam is rotatable about an axis, the cam has a curved pressing surface, the curved pressing surface has a first side and a second side opposite to each other, a distance between the curved pressing surface and the axis decreases from the first side to the second side; when the cam is rotated relative to the main frame, the movable part is moved toward or away from the fixed part by being pushed by the curved pressing surface so as to adjust the clamping strength of the clamping part.

3. The bicycle rear derailleur according to claim 2, wherein the mounting frame assembly further comprises a shaft, the shaft is disposed through the cam, and the cam is rotatable between a strengthening position and a releasing position by being driven by the shaft; a distance between the movable part and the fixed part becomes smaller when the cam is moved from the releasing position to the strengthening position.

4. The bicycle rear derailleur according to claim 3, wherein the mounting frame assembly further comprises a handle, the handle is connected to one end of the shaft in order to rotate the shaft.

5. The bicycle rear derailleur according to claim 4, further comprising a gasket, the gasket located between the main frame and the bicycle frame, the gasket adapted to be fixed on the bicycle frame, the pivot disposed through the main frame and the gasket, and the main frame rotatable with respect to the gasket.

6. The bicycle rear derailleur according to claim 5, wherein the shaft has a pressing end away from the handle, the main frame is rotatable to a first position and a second position; when the main frame is in the first position, the pressing end is next to a surface of the gasket facing the main frame; when the main frame is in the second position, the shaft is movable between a third position and a fourth position along the axis; when the shaft is in the third position, the main frame is rotatable between the first position and the second position; when the shaft is in the fourth position, the pressing end of the shaft is pressed against a press edge of the surface.

7. The bicycle rear derailleur according to claim 6, wherein the main frame has a recess; when the cam is rotated to the releasing position, the handle is next to the mouth of the recess, allowing the handle to move the shaft along the axis.

8. The bicycle rear derailleur according to claim 7, wherein the handle has a first positioning portion at one end away from the shaft, the main frame has a second positioning portion; when the cam is rotated to the strengthening position by the shaft, the first positioning portion is engaged with the second positioning portion.

9. The bicycle rear derailleur according to claim 8, further comprising a control assembly, the control assembly comprising a sensor and a driver, the sensor disposed between the curved pressing surface of the cam and the movable part of the clamping sleeve, the sensor configured for detecting the force, on the movable part, applied by the cam, the driver disposed on the main frame, and the driver configured for rotating the cam.

10. A bicycle rear derailleur, adapted to be mounted on a bicycle frame, comprising:
a mounting frame assembly, comprising:
a pivot, adapted to be fixed on the bicycle frame;
a main frame, rotatably disposed on the pivot;
a gasket, located between the main frame and the bicycle frame, the gasket adapted to be fixed on the bicycle frame, the pivot disposed through the main frame and the gasket, and the main frame rotatable with respect to the gasket; and
a shaft, disposed through the main frame;
a linkage assembly, pivoted to the mounting frame assembly; and
a movable assembly, pivoted to the linkage assembly;
wherein, the main frame is rotatable to a first position and a second position, and the shaft has a pressing end; when the main frame is in the first position, the pressing end is next to a surface of the gasket facing the main frame; when the main frame is in the second position, the shaft is movable along an axis thereof, allowing the pressing end of the shaft to press against the gasket.

11. The bicycle rear derailleur according to claim 10, wherein when the main frame is in the second position, the shaft is movable along the axis, allowing the pressing end of the shaft to press against a press edge of the surface.

12. The bicycle rear derailleur according to claim 11, wherein the mounting frame assembly further comprises a handle, the handle is connected to one end of the shaft opposite to the pressing end, and the handle is configured to move the shaft along the axis.
